(19) United States
(12) Patent Application Publication
(10) Pub. No.: US 2007/0241280 A1
(43) Pub. Date: Oct. 18, 2007

(54) Apparatus for measuring concentration of gas

(75) Inventors: Hidetoshi Dainobu, Tokyo (JP); Shinji Yamamori, Tokyo (JP)

Correspondence Address: SUGHRUE-265550, 2100 PENNSYLVANIA AVE. NW, WASHINGTON, DC, 20037-3213, US

(73) Assignee: NIHON KOHDEN CORPROATION, Shinjuku-ku (JP)

(21) Appl. No.: 11/785,341

(22) Filed: Apr. 17, 2007

(30) Foreign Application Priority Data
Apr. 17, 2006 (JP) 2006-113028

(51) Int. Cl. G01N 21/35; G01J 5/02

(52) U.S. Cl. 250/343

(57) ABSTRACT

In an apparatus for measuring concentration of prescribed gas contained in subject gas, a light source is operable to emit infrared light. Airway adapter is adapted to introduce the subject gas, and to allow the infrared light emitted from the light source. A beam splitter is adapted to allow the infrared light which has passed through the airway adapter to be reflected and passed through. A first detector is operable to detect the infrared light which has reflected by the beam splitter. A second detector is operable to detect the infrared light which has passed through the beam splitter. An interference-type notch filter is disposed between the beam splitter and either the first detector or the second detector, the notch filter being adapted to cut a wavelength range of light which is absorbed by the prescribed gas.

### BACKGROUND

The present invention relates to an apparatus for measuring, through the use of transmission of infrared light, concentration of gas such as carbon dioxide gas contained in, for example, respiratory gas of a living body.

Non-dispersive infrared radiation analyzers are known as apparatus for measuring the concentration of carbon dioxide gas contained in respiratory gas. Analyzers of this type are configured so as to measure the concentration of carbon dioxide gas by causing respiratory gas to transmit the infrared light that is emitted from a light source and measuring the absorption amount of light in a wavelength of absorption by carbon dioxide gas.

Among conventional apparatus for measuring concentration of carbon dioxide gas is an apparatus which is equipped with a detachable airway adaptor for introduction of respiratory gas and measures carbon dioxide gas concentration by causing the airway adaptor to transmit infrared light emitted from a light source and detecting infrared light beams that are separated by a beam splitter.

FIG. 7 shows such a conventional apparatus disclosed in Japanese Patent Publication No. 5-508473T. This apparatus comprises an airway adaptor 10, a beam splitter 12 for reflecting and transmitting -incident infrared light, a second detector 16 for detecting, via a 3.7-μm band-pass filter 13, the infrared light reflected by the beam splitter 12, and a first detector 14 for detecting, via a 4.3-μm band-pass filter 15, the infrared light transmitted by the beam splitter 12.

As seen from a transmission spectrum of carbon dioxide gas (CO₂) shown in FIG. 8, the transmittance of carbon dioxide gas is lowest at about a wavelength 4.3 μm and is about 100% (almost no attenuation in transmittance) at a wavelength 3.7 μm. Therefore, the measuring apparatus having the above configuration can calculate carbon dioxide gas concentration by calculating the ratio between electrical signals that are output from the first and second detectors 14 and 16 in accordance with the incident light intensity.

In the above carbon dioxide gas concentration measuring apparatus, the airway adaptor 10 is provided with, at both ends in the transmission direction of the light emitted from the light source 18, sapphire windows 11a and 11b which are high in infrared transmittance. When an inspiration or expiration gas has passed through the inside of the airway adaptor 10, minuscule water droplets are adhered to the inside surfaces of the above windows. Since light is scattered by those water droplets, the windows are fogged and the light intensity passing through the windows is varied. To prevent a measurement error due to this phenomenon, a heater or the like may be provided to prevent the windows being fogged. However, the heater has problems that it requires a warm-up time and is high in power consumption.

Alternatively, hydrophilic anti-fogging treatment may be performed to render the inside surfaces of the windows of the airway adaptor 10. As a result, the water that is adhered to the inside surfaces of the windows assumes a thin layer having a uniform thickness rather than minuscule water droplets, whereby incident light is not scattered and the windows are not fogged. However, as seen from FIG. 8, the light transmittance of water shows different wavelengths at 3.7 μm and 4.3 μm. Therefore, when water layers are formed on the inside surfaces of the windows, the ratio between the intensities of the light beams incident on the detectors 14 and 16 varies to cause a measurement error. For this reason, the anti-fogging treatment is not applicable to the above conventional measuring apparatus.

In the above conventional measuring apparatus, a heat source, a lamp, or the like is employed as the light source 18. However, when its heat temperature varies due to degradation or a drift, the light emission intensities at a wavelength 3.7 μm and a wavelength 4.3 μm do not vary by the same rate as the Planck's law of blackbody radiation shows, which results in a variation in the ratio between the light emission intensities. Furthermore, if the inside surfaces of the light transmission windows of the airway adaptor 10 are soiled by secretion from a subject such as sputum which exhibits different infrared absorption amounts at a wavelength 3.7 μm and a wavelength 4.3 μm, the secretion affects the calculation (measurement) of carbon dioxide gas concentration.

FIG. 9 shows an apparatus for measuring concentration of carbon dioxide gas concentration disclosed in U.S. Pat. No. 6,191,421. For the convenience of description, components similar to those in the measuring apparatus shown in FIG. 7 will be designated by the same reference numerals and repetitive explanations for those will be omitted.

In this apparatus, to increase the infrared transmittance, films 11c and 11d which are thin polyethylene films or the like and were subjected to anti-fogging treatment are disposed at both end surfaces in the optical axis direction of the light source 18 as light transmission windows of the airway adaptor 10, whereby preventing sticking of minuscule water droplets (fogging) due to passage of highly moist expiratory or inspiratory air.

Further, a gas cell 20 in which a high-concentration carbon dioxide gas is sealed is disposed between the beam splitter 12 and the second detector 16 which outputs an electrical signal corresponding to the intensity of the incident infrared light that has passed through the band-pass filter 15 having a center wavelength 4.3 μm, for example, and the beam splitter 12. The gas cell 20 is given a filter function of absorbing an infrared light component having a wavelength 4.3 μm and transmitting the remaining part of the infrared light.

With this configuration, the spectrum of the infrared light incident on the first detector 14 after being reflected by the beam splitter 12 is as shown in FIG. 10A when no carbon dioxide gas exists in the airway adaptor 10, and as shown in FIG. 10B when carbon dioxide gas exists in the airway adaptor 10. That is, the infrared light quantity varies depending on whether or not carbon dioxide gas exists.

On the other hand, as shown in FIG. 11, the intensity of the infrared light incident on the second detector 16 via the gas cell 20 is the same irrespective of whether or not carbon dioxide gas exists because of strong absorption by the high-concentration carbon dioxide gas in the gas cell 20. That is, even if the amount (concentration) of carbon dioxide gas in the airway adaptor 10 is varied, a resulting variation of the infrared light quantity detected by the second detector 16 is slight. Therefore, carbon dioxide gas concentration can be calculated by calculating the ratio between the intensities of the infrared light beams incident on the detectors 14 and 16. Since the first and second detectors 14 and 16 are to detect infrared light beams having the same wavelength 4.3 μm, the intensities of infrared light beams incident on the first and second detectors 14 and 16 decrease by the same rate even if thin water layers are formed on the inside surfaces of the anti-fogging films 11c and 11d due to passage of respiratory gas. Therefore, the ratio between the intensities of infrared light beams incident on the detectors 14 and 16 is not varied and a measurement error due to the water layers can be avoided. For the same reason, a measurement error due to degradation or a drift of the light source 18 or secretion from a subject such as sputum can also be avoided.

Japanese Patent Publication No. 58-223040A discloses an apparatus for measuring concentration of carbon dioxide in which a chopper which is provided with a wavelength 3.7-μm band-pass filter and a wavelength 4.3-μm band-pass filter is disposed on the optical path of the infrared light that has passed through an airway adaptor. In this apparatus, as the chopper is rotated by a motor, the two band-pass filters intersect the optical path alternately and a detector detects 3.7-μm infrared light and 4.3-μm infrared light alternately. Carbon dioxide gas concentration can be calculated by calculating the ratio between resulting two detection signals. Furthermore, providing the chopper with plural band-pass filters makes it possible to easily analyze plural kinds of gas simultaneously. For example, carbon dioxide gas and nitrous oxide gas (N₂O) can be analyzed simultaneously by adding a band-pass filter having a center wavelength 3.9 μm to the chopper, because the nitrous oxide gas strongly absorbs infrared light having a wavelength 3.9 μm. However, even this type of apparatus has problems that a heater is needed for anti-fogging and hence the power consumption is high. A warm-up time is also necessary.

As described above, in the conventional measuring apparatus which measures carbon dioxide gas concentration using infrared light beams of two wavelengths, inexpensive anti-fogging films cannot be used as infrared light transmission windows of the airway adaptor and a heater needs to be provided. As such, this apparatus has demerits of being complex in configuration and expensive. The gas cell is effective in solving these problems. That is, the use of the gas cell makes it possible to employ inexpensive anti-fogging films in the airway adaptor and to enable proper carbon dioxide gas concentration measurements by preventing fogging.

However, in this case, it is necessary to seal gas in the gas cell and to prevent its leakage. This raises problems of increase in manufacturing cost, difficulty in reducing the size of the entire apparatus, etc.

### SUMMARY

It is therefore one advantageous aspect of the present invention to provide a measuring apparatus which allows use of anti-fogging films, enables downsizing of the apparatus, and can easily realize increase in reliability and reduction in manufacturing cost by making the apparatus less prone to be affected by water in an airway adapter.

According to one aspect of the invention, there is provided an apparatus for measuring concentration of prescribed gas contained in subject gas, comprising:

a light source, operable to emit infrared light;

airway adapter, adapted to introduce the subject gas, and to allow the infrared light emitted from the light source;

a beam splitter, adapted to allow the infrared light which has passed through the airway adapter to be reflected and passed through;

a first detector, operable to detect the infrared light which has reflected by the beam splitter;

a second detector, operable to detect the infrared light which has passed through the beam splitter; and

an interference-type notch filter, disposed between the beam splitter and either the first detector or the second detector, the notch filter being adapted to cut a wavelength range of light which is absorbed by the prescribed gas.

The apparatus may further comprise a first band-pass filter, disposed between the light source and the beam splitter, and adapted to allow a first wavelength range of light to pass through. A center wavelength of the first wavelength range may be 4.3 μm.

The apparatus may further comprise a second band-pass filter, disposed between the beam splitter and the first detector, and adapted to allow a second wavelength range of light to pass through. The notch filter may be disposed between the beam splitter and the second detector.

A bandwidth of the first wavelength range may be 120-300 nm. A center wavelength of the second wavelength range may be 4.31 μm. A bandwidth of the second wavelength range may be narrower than the bandwidth of the first wavelength range.

The bandwidth of the second wavelength range may be 10-110 nm.

The apparatus may further comprise a second band-pass filter, disposed between the beam splitter and the second detector, and adapted to allow a second wavelength range of light to pass through. The notch filter may be disposed between the beam splitter and the first detector.

A bandwidth of the first wavelength range may be 120-300 nm. A center wavelength of the second wavelength range may be 4.3 μm. A bandwidth of the second wavelength range may be narrower than the bandwidth of the first wavelength range.

The bandwidth of the second wavelength range may be 10-110 nm.

The apparatus may further comprise:

a first band-pass filter, disposed between the notch filter and either the second detector or the beam splitter, and adapted to allow a first wavelength range of light to pass through; and

a second band-pass filter, disposed between the beam splitter and the first detector, and adapted to allow a second wavelength range of light to pass through.

The notch filter may be disposed between the beam splitter and the second detector.

A bandwidth of the first wavelength range may be 120-300 nm. A center wavelength of the second wavelength range may be 4.3 μm. A bandwidth of the second wavelength range may be narrower than the bandwidth of the first wavelength range.

The bandwidth of the second wavelength range may be 10-110 nm.

The apparatus may further comprise:

a first band-pass filter, disposed between the notch filter and either the first detector or the beam splitter, and adapted to allow a first wavelength range of light to pass through; and

a second band-pass filter, disposed between the beam splitter and the second detector, and adapted to allow a second wavelength range of light to pass through.

The notch filter may be disposed between the beam splitter and the first detector.

A bandwidth of the first wavelength range may be 120-300 nm. A center wavelength of the second wavelength range may be 4.3 μm. A bandwidth of the second wavelength range may be narrower than the bandwidth of the first wavelength range.

The bandwidth of the second wavelength range may be 10-110 nm.

The airway adapter may comprise windows through which the infrared light emitted form the light source passes. Anti-fogging treatment may be provided on the windows.

According to one aspect of the invention, there is provided an apparatus for measuring concentration of prescribed gas contained in subject gas, comprising:

a light source, operable to emit infrared light;

airway adapter, adapted to introduce the subject gas, and to allow the infrared light emitted from the light source;

a detector, operable to detect infrared light;

an interference-type notch filter, provided on the chopper and adapted to cut a wavelength range of light which is absorbed by the prescribed gas; and

a chopper, provided with the notch filter and disposed between the airway adapter and the detector, the chopper operable to cause the infrared light which has passed through the airway adapter to pass through the notch filter intermittently.

The apparatus may further comprise a first band-pass filter, disposed between the light source and the detector, and adapted to allow a first wavelength range of light to pass through.

The apparatus as set forth may further comprise a second band-pass filter, provided on the chopper and adapted to allow a second wavelength range of light to pass through.

The apparatus may further comprise: a first band-pass filter, provided on the chopper, and adapted to allow a first wavelength range of light to pass through; and a second band-pass filter, provided on the chopper, and adapted to allow a second wavelength range of light to pass through. The notch filter and the first band-pass filter may be aligned on the same optical path of the infrared light.

The airway adapter may comprise windows through which the infrared light emitted form the light source passes. Anti-fogging treatment may be provided on the windows.

### BRIEF DESCRIPTION OF THE DRAWINGS

FIG. 1 is a schematic view showing an apparatus for measuring concentration of carbon dioxide gas according to a first embodiment of the invention.

FIG. 2A shows a spectrum of infrared light which has passed through a first band-pass filter in the measuring apparatus of FIG. 1, showing a case that measured gas contains no carbon dioxide gas.

FIG. 2B shows a spectrum of infrared light which has passed through the first band-pass filter in the measuring apparatus of FIG. 1, showing a case that measured gas contains carbon dioxide gas.

FIG. 3A shows a spectrum of infrared light which has been reflected by a beam splitter and has passed through a second band-pass filter in the measuring apparatus of FIG. 1, showing a case that measured gas contains no carbon dioxide gas.

FIG. 3B shows a spectrum of infrared light which has been reflected by the beam splitter and has passed through the second band-pass filter in the measuring apparatus of FIG. 1, showing a case that measured gas contains carbon dioxide gas.

FIG. 4 shows a spectrum of infrared light incident on a second detector in the measuring apparatus of FIG. 1.

FIG. 5 is a schematic view showing an apparatus for measuring concentration of carbon dioxide gas according to a second embodiment of the invention.

FIG. 6A is a schematic view showing an apparatus for measuring concentration of carbon dioxide gas according to a third embodiment of the invention.

FIG. 6B is a schematic view showing an apparatus for measuring concentration of carbon dioxide gas according to a first modified example of the third embodiment.

FIG. 6C is a schematic view showing an apparatus for measuring concentration of carbon dioxide gas according to a second modified example of the third embodiment.

FIG. 7 is a schematic view showing an apparatus for measuring concentration of carbon dioxide gas according to a first conventional example.

FIG. 8 shows infrared transmittance spectra of carbon dioxide gas and water.

FIG. 9 is a schematic view showing an apparatus for measuring concentration of carbon dioxide gas according to a second conventional example.

FIG. 10A shows a spectrum of infrared light which has been reflected by a beam splitter and incident on a first detector in the measuring apparatus of FIG. 9, showing a case that measured gas contains no carbon dioxide gas.

FIG. 10B shows a spectrum of infrared light which has been reflected by the beam splitter and incident on the first detector in the measuring apparatus of FIG. 9, showing a case that measured gas contains carbon dioxide gas.

FIG. 11 shows a spectrum of infrared light which has passed through the beam splitter and a gas cell in the measuring apparatus of FIG. 9.

### DETAILED DESCRIPTION OF THE EXEMPLARY EMBODIMENTS

Exemplary embodiments of the invention will be described below in detail with reference to the accompanying drawings.

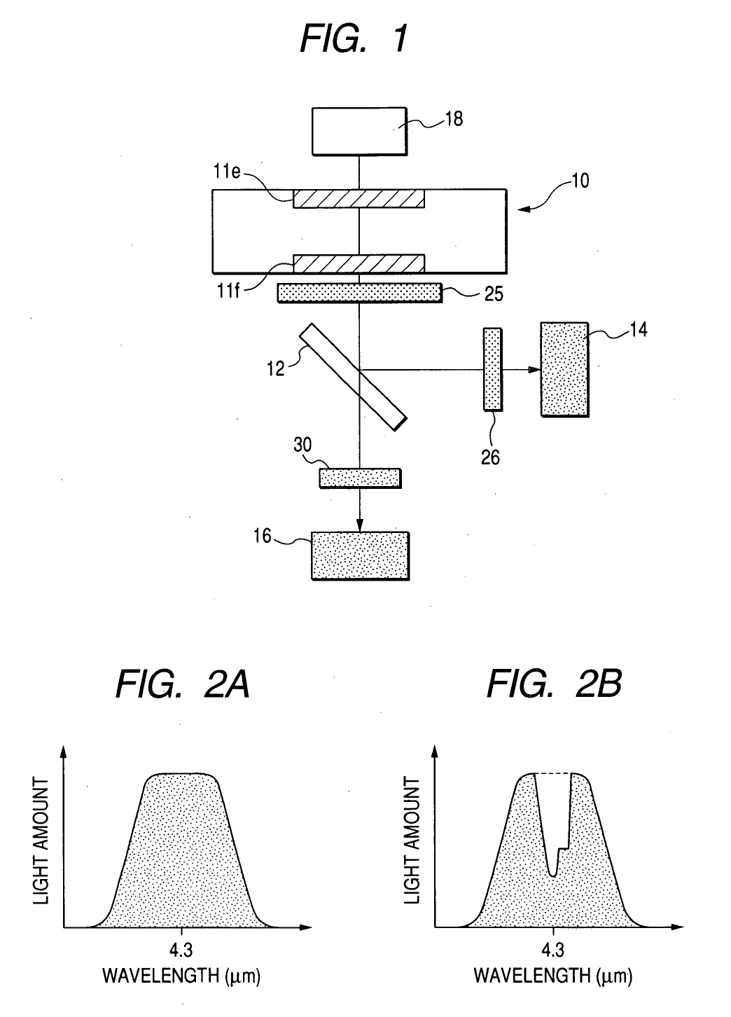

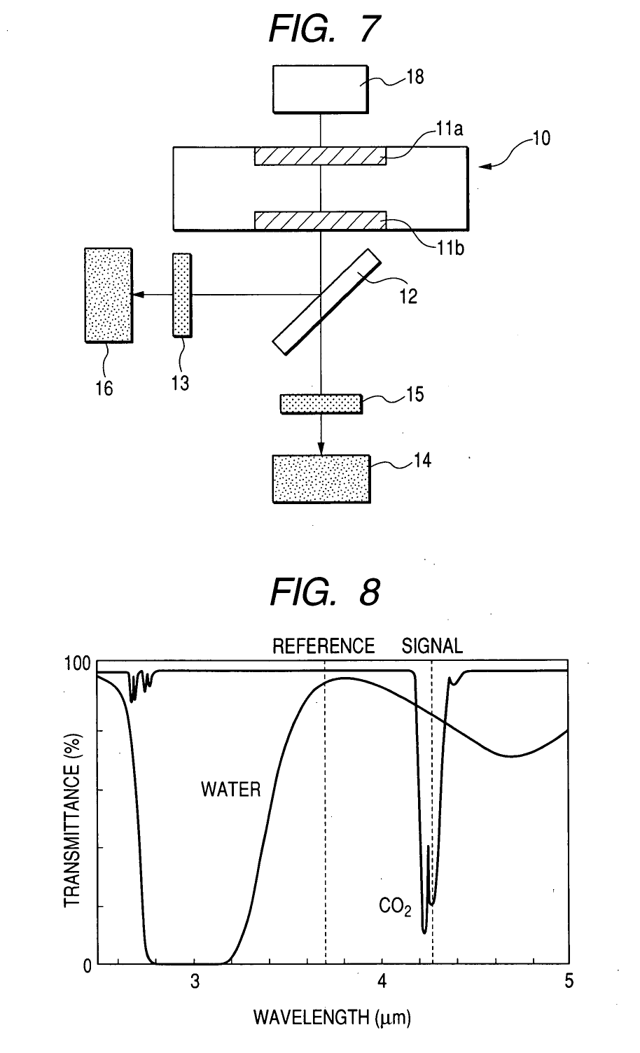

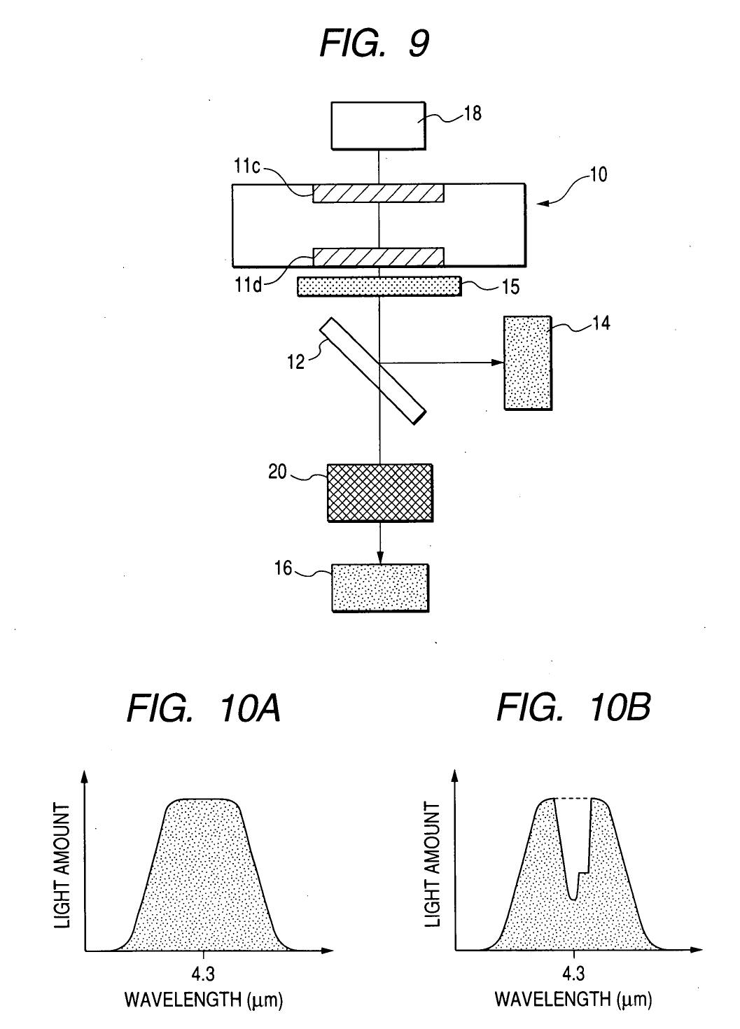

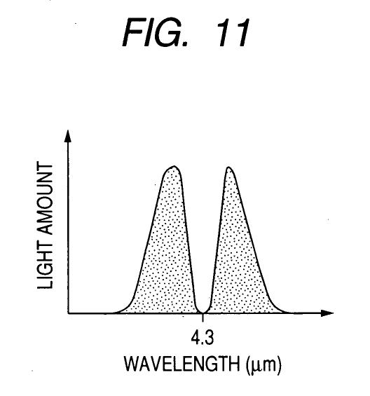

FIG. 1 shows an apparatus for measuring concentration of carbon dioxide gas in respiratory gas of a living body, according to a first embodiment of the invention. For the convenience of description, components similar to those in the conventional measuring apparatus shown in FIG. 7 will be designated by the same reference numerals, and repetitive explanations for those will be omitted.

The measuring apparatus comprises an airway adaptor 10 for introduction of carbon dioxide gas, a light source 18 for emitting infrared light to be transmitted by the airway adaptor 10, a beam splitter 12 for reflecting and transmitting the infrared light that has passed through the airway adaptor 10, a first detector 14 for detecting the infrared light reflected by the beam splitter 12, and a second detector 16 for detecting the infrared light transmitted by the beam splitter 12.

In this embodiment, the airway adaptor 10 is configured as a passage which allows gas subjected to measurement to pass therethrough and allows infrared to transmit therethrough. To increase the transmittance of infrared light, anti-fogging films 11e and 11f which are thin polyethylene films, for example, are provided inside the airway adaptor 10 as infrared light transmission windows. The above configuration is the same as in the measuring apparatus disclosed in U.S. Pat. No. 6,191,421.

In this embodiment, an optical filter 30 which cuts infrared light having a prescribed wavelength (4.3 μm) at which carbon dioxide gas exhibits a remarkable absorption characteristic is disposed upstream from the second detector 16 for detecting the infrared light transmitted by the beam splitter 12. The optical filter 30 is an interference-type notch filter which cuts infrared light having a wavelength 4.3 μm. Here, the interference-type notch filter is a filter fabricated by laminating thin film coatings having high refractive index and thin films having low refractive index on a substrate, thereby utilizing light interference phenomenon.

In this embodiment, a first band-pass filter 25 whose center wavelength is set at 4.3 μm is disposed between the light source 18 and the beam splitter 12. And a second band-pass filter 26 whose center wavelength is set at 4.3 μm is disposed between the beam splitter 12 and the first detector 14 for detecting the infrared light reflected by the beam splitter 12.

As for the first band-pass filter 25, not only is the center wavelength set at 4.3 μm but also the bandwidth is set at 250 nm, for example. As for the second band-pass filter 26, not only is the center wavelength set at 4.3 μm but also the bandwidth is set at 80 nm, for example. As for the optical filter 30, not only is the center wavelength set at 4.3 μm but also the bandwidth is set at 110 nm, for example.

With the above configuration, when carbon dioxide gas concentration is measured by introducing respiratory gas into the airway adaptor 10, the infrared light that has passed through the first band-pass filter 25 has a spectrum shown in FIGS. 2A and 2B. Specifically, a spectrum shown in FIG. 2A is obtained if the respiratory gas contains no carbon dioxide gas and a spectrum shown in FIG. 2B is obtained if the respiratory gas contains carbon dioxide gas. The light intensity varies depending on the presence/absence of carbon dioxide gas.

The infrared light that is incident on the second detector 16 after passing through the first band-pass filter 25, the beam splitter 12, and the optical filter 30 has a spectrum shown in FIG. 4. That is, the spectrum has a considerable attenuation at the center wavelength 4.3 μm irrespective of whether or not the respiratory gas contains carbon dioxide gas.

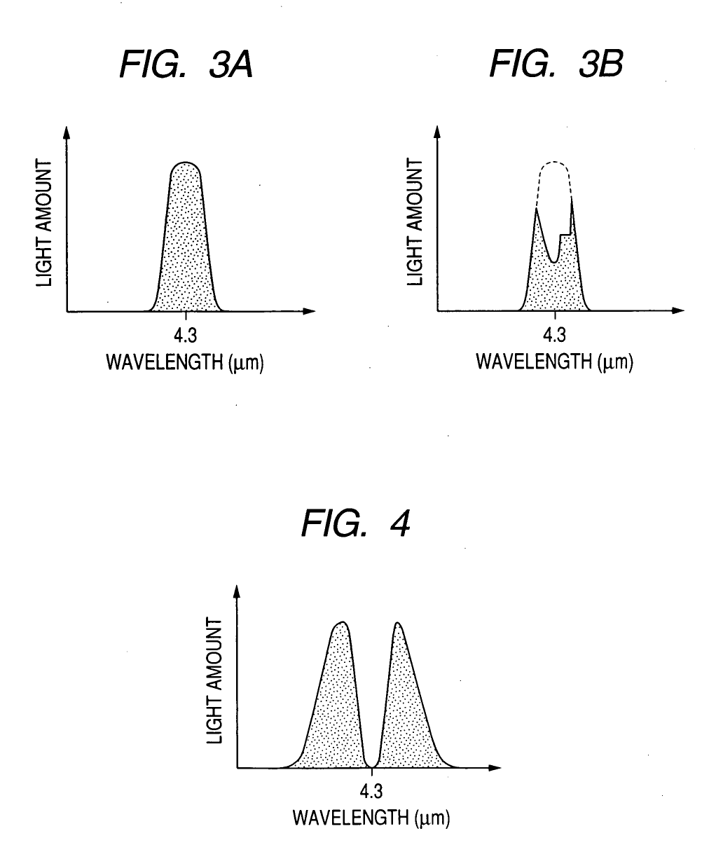

The infrared light that is incident on the first detector 14 after passing through the first band-pass filter 25, being reflected by the beam splitter 12, and passing through the second band-pass filter 26 has a spectrum shown in FIGS. 3A and 3B. Specifically, a spectrum shown in FIG. 3A is obtained if the respiratory gas contains no carbon dioxide gas and a spectrum shown in FIG. 3B is obtained if the respiratory gas contains carbon dioxide gas. The light intensity varies depending on the presence/absence of carbon dioxide gas. Therefore, carbon dioxide gas concentration can be calculated based on the ratio between the light intensities of the infrared light beams incident on the detectors 14 and 16.

As described above, in this embodiment, the bandwidth of the second band-pass filter 26 is set smaller than (e.g., set at a half or less of) that of the first band-pass filter 25, whereby the light intensity of the infrared light detected by the first detector 14 varies to a large extent depending on whether or not the respiratory gas contains carbon dioxide gas. As a result, the sensitivity and reliability of the carbon dioxide gas concentration measurement can be increased. Here, the positions of the optical filter 30 and the second band-pass filter 26 may be exchanged.

In this embodiment, it is preferable that the bandwidth of the first band-pass filter 25 be large, because it is desirable that the light intensity detected by the second detector 16 disposed on the side where the optical filter 30 is provided varies by only a small value when carbon dioxide gas exists in the airway filter 10 in which respiratory gas is introduced. On the other hand, it is preferable that the bandwidth of the second band-pass filter 26 be small, because it is advantageous that the light intensity detected by the first detector 14 disposed on the side without the optical filter 30 varies to a large extent when carbon dioxide gas exists in the airway filter 10. These conditions can be satisfied at the same time by using at least two band-pass filters, whereas they cannot be satisfied at the same time even if only one band-pass filter is provided.

With the above configuration, the measurement of carbon dioxide gas concentration can be measured without using a gas cell while allowing the use of anti-fogging films in the airway adapter. Accordingly, it is possible to eliminate affection of water in the airway adapter with respect to the measurement, thereby enhancing reliability of the measurement. On the other hand, the downsizing of the apparatus can be attained and the manufacturing costs can be reduced.

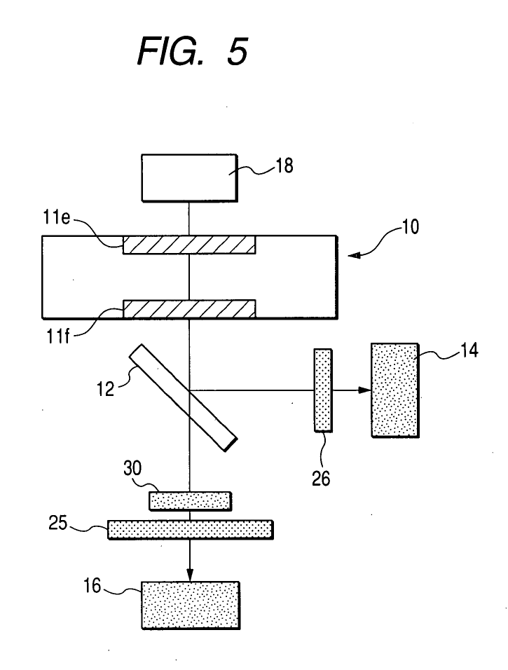

FIG. 5 shows a second embodiment of the invention. Components similar to those in the first embodiment will be designated by the same reference numerals, and repetitive explanations for those will be omitted.

In this embodiment, the first band-pass filter 25 is disposed on an optical path between the beam splitter 12 and the second detector 16.

The measuring apparatus of this embodiment can measure carbon dioxide gas concentration in the same manner as in the first embodiment. Here, the positions of the second band-pass filter 26 and the set of the optical filter 30 and the first band-pass filter 25 may be exchanged.

As for the first band-pass filter 25, since infrared light in such a band as to be absorbed by carbon dioxide gas is cut by the optical filter 30, the bandwidth of the first band-pass filter 25 needs to be larger than that of the rejection bandwidth of the optical filter 30. Furthermore, since N₂O absorbs infrared light in a wavelength range of 4.45 to 4.55 μm, if the bandwidth of the first band-pass filter 25 were set unduly large, influence of N₂O would appear in a spectrum. The bandwidth should be set so as to avoid influence of N₂O. However, if the bandwidth were increased by shifting the center wavelength to the shorter-wavelength side, influence of the absorption by water could not be removed. That is, to remove the influence of the absorption by water, it is desirable that the center frequency of the two band-pass filters be the same. In conclusion, it is preferable that the bandwidth of the first band-pass filter 25 be in such a range that no influence of N₂O occurs in a spectrum and the center wavelengths of the two band-pass filters coincide with each other. It is even preferable that the bandwidth be in an approximate range of 120 to 300 nm.

As for the second band-pass filter 26, it is desirable that its bandwidth be set at a half or less of the bandwidth of the first band-pass filter 25 which is disposed on the side where the optical filter 30 is provided. This is because if the bandwidth of the second band-pass filter 26 were approximately equal to or smaller than that of the absorption curve of carbon dioxide gas (CO₂), the intensity of detected infrared light varies to a large extent, that is, the sensitivity to CO₂ becomes high. An even preferable range of the bandwidth is 10 to 110 nm, and the bandwidth is set at 80 nm in the embodiment. However, the bandwidth of the absorption curve of CO₂ varies depending on the carbon dioxide gas concentration, the optical path length of the airway adaptor 10, and other factors, the bandwidth range need not be limited to 10 to 110 nm.

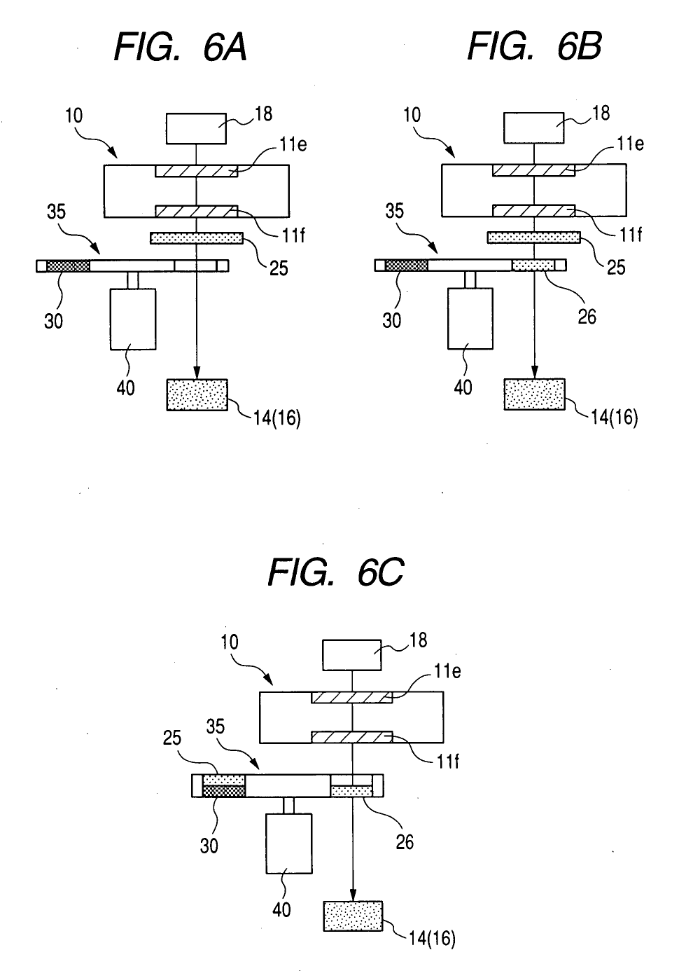

FIG. 6A shows a third embodiment of the invention. Components similar to those in the first embodiment will be designated by the same reference numerals, and repetitive explanations for those will be omitted.

In this embodiment, a chopper 35 provided with the above-described optical filter 30 is disposed downstream from the first band-pass filter 25 on the optical path of the infrared light that has passed through the airway adaptor 10. The chopper 30 is rotated by a motor 40.

The optical filter 30 is an interference-type notch filter which cuts infrared light at a prescribed wavelength at which measurement subject gas exhibits an absorption characteristic. The first band-pass filter 25 transmits infrared light having the prescribed wavelength at which the measurement subject gas exhibits an absorption characteristic, and its bandwidth is set larger than the bandwidth of the optical filter 30.

As the chopper 35 is rotated by the motor 40, the optical filter 30 overlaps with the first band-pass filter 25 intermittently on the optical path and the infrared detector 14 (or 16) detects infrared light beams having different wavelength ranges alternately in the same manner as described in the above embodiments. Carbon dioxide gas concentration can be calculated by calculating the ratio between resulting two detection signals.

FIG. 6B shows a first modified example of the third embodiment. In this case, the optical filter 30 and the second band-pass filter 26 are disposed in the chopper 35 at 180-degrees intervals in the circumferential direction of the chopper 35. The second band-pass filter 26 transmits infrared light at a prescribed wavelength at which measurement subject gas exhibits absorption characteristic and its bandwidth is set smaller than the bandwidth of the first band-pass filter 25.

With this configuration, as the chopper 35 is rotated by the motor 40, the optical filter 30 and the second band-pass filter 26 overlap with the first band-pass filter 25 alternately on the optical path and the infrared detector 14 (or 16) detects infrared light beams having different wavelength ranges alternately in the same manner as described in the above embodiments. Carbon dioxide gas concentration can be calculated by calculating the ratio between resulting two detection signals.

FIG. 6C shows a second modified example of the third embodiment. In this case, the optical filter 30 (first band-pass filter 25) and the second band-pass filter 26 are disposed in the chopper 35 at 180-degrees intervals in the circumferential direction of the chopper 35.

With this configuration, as the chopper 35 is rotated by the motor 40, the second band-pass filter 26 and the set of the optical filter 30 and the first band-pass filter 25 intersect the optical path alternately and the infrared detector 14 (or 16) detects infrared light beams having different wavelength ranges alternately in the same manner as described in the above embodiments. Carbon dioxide gas concentration can be calculated by calculating the ratio between resulting two detection signals.

For the cases shown in FIGS. 6A and 6B, satisfactory results can be obtained as long as the chopper 35 and the first band-pass filter 25 are disposed between the light source 18 and the infrared detector 14 (or 16) and their positions may be exchanged. For the case shown in FIG. 6C, satisfactory results can be obtained as long as the chopper 35 is disposed between the light source 18 and the infrared detector 14 (or 16) and the positions of the chopper 35 and the airway adaptor 10 may be exchanged.

Although the preferred embodiments of the invention have been described above, the invention is not limited to the measurement of the concentration of carbon dioxide gas in respiratory gas to which the embodiments are directed and can be applied to the measurement of concentration of prescribed gas component contained in another subject gas. For example, since N₂O absorbs infrared light strongly at a wavelength 3.9 μm, its concentration can be measured by providing an optical filter (notch filter) and band-pass filters whose center wavelengths are set at 3.9 μm. Furthermore, since volatile anesthetic agents such as halothane, enflurane, isoflurane, and sevoflurane have absorption bands in a wavelength range of 7 to 15 μm, the concentration of each of those volatile anesthetics can be measured by providing an optical filter (notch filter) and band-pass filters whose center wavelengths and bandwidths are set at proper values. Other various design modifications are possible without departing from the spirit and scope of the invention.

The disclosure of Japanese Patent Application No. 2006-113028 filed Apr. 17, 2006 including specification, drawings and claims is incorporated herein by reference in its entirety.

What is claimed is:

1. An apparatus for measuring concentration of prescribed gas contained in subject gas, comprising:
a light source, operable to emit infrared light;
airway adapter, adapted to introduce the subject gas, and to allow the infrared light emitted from the light source;
a beam splitter, adapted to allow the infrared light which has passed through the airway adapter to be reflected and passed through;
a first detector, operable to detect the infrared light which has reflected by the beam splitter;
a second detector, operable to detect the infrared light which has passed through the beam splitter; and
an interference-type notch filter, disposed between the beam splitter and either the first detector or the second detector, the notch filter being adapted to cut a wavelength range of light which is absorbed by the prescribed gas.

2. The apparatus as set forth in claim 1, further comprising:
a first band-pass filter, disposed between the light source and the beam splitter, and adapted to allow a first wavelength range of light to pass through, wherein:
a center wavelength of the first wavelength range is 4.3 μm.

3. The apparatus as set forth in claim 2, further comprising:
a second band-pass filter, disposed between the beam splitter and the first detector, and adapted to allow a second wavelength range of light to pass through, wherein:
the notch filter is disposed between the beam splitter and the second detector.

4. The apparatus as set forth in claim 2, further comprising:
a second band-pass filter, disposed between the beam splitter and the second detector, and adapted to allow a second wavelength range of light to pass through, wherein:
the notch filter is disposed between the beam splitter and the first detector.

5. The apparatus as set forth in claim 1, further comprising:
a first band-pass filter, disposed between the notch filter and either the second detector or the beam splitter, and adapted to allow a first wavelength range of light to pass through; and
a second band-pass filter, disposed between the beam splitter and the first detector, and adapted to allow a second wavelength range of light to pass through, wherein:
the notch filter is disposed between the beam splitter and the second detector.

6. The apparatus as set forth in claim 1, further comprising:
a first band-pass filter, disposed between the notch filter and either the first detector or the beam splitter, and adapted to allow a first wavelength range of light to pass through; and
a second band-pass filter, disposed between the beam splitter and the second detector, and adapted to allow a second wavelength range of light to pass through, wherein:
the notch filter is disposed between the beam splitter and the first detector.

7. The apparatus as set forth in claim 3, wherein:
a bandwidth of the first wavelength range is 120-300 nm;
a center wavelength of the second wavelength range is 4.3 μm; and
a bandwidth of the second wavelength range is narrower than the bandwidth of the first wavelength range.

8. The apparatus as set forth in claim 4, wherein:
a bandwidth of the first wavelength range is 120-300 nm;
a center wavelength of the second wavelength range is 4.3 μm; and
a bandwidth of the second wavelength range is narrower than the bandwidth of the first wavelength range.

9. The apparatus as set forth in claim 5, wherein:
a bandwidth of the first wavelength range is 120-300 nm;
a center wavelength of the second wavelength range is 4.3 μm; and
a bandwidth of the second wavelength range is narrower than the bandwidth of the first wavelength range.

10. The apparatus as set forth in claim 6, wherein:
a bandwidth of the first wavelength range is 120-300 nm;
a center wavelength of the second wavelength range is 4.3 μm; and
a bandwidth of the second wavelength range is narrower than the bandwidth of the first wavelength range.

11. The apparatus as set forth in claim 3, wherein:
the bandwidth of the second wavelength range is 10-110 nm.

12. The apparatus as set forth in claim 4, wherein:
the bandwidth of the second wavelength range is 10-110 nm.

13. The apparatus as set forth in claim 5, wherein:
the bandwidth of the second wavelength range is 10-110 nm.

14. The apparatus as set forth in claim 6, wherein:
the bandwidth of the second wavelength range is 10-110 nm.

15. The apparatus as set forth in claim 1, wherein:
the airway adapter comprises windows through which the infrared light emitted form the light source passes; and
anti-fogging treatment is provided on the windows.

16. An apparatus for measuring concentration of prescribed gas contained in subject gas, comprising:
a light source, operable to emit infrared light;
airway adapter, adapted to introduce the subject gas, and to allow the infrared light emitted from the light source;
a detector, operable to detect infrared light;
an interference-type notch filter, provided on the chopper and adapted to cut a wavelength range of light which is absorbed by the prescribed gas; and
a chopper, provided with the notch filter and disposed between the airway adapter and the detector, the chopper operable to cause the infrared light which has passed through the airway adapter to pass through the notch filter intermittently.

17. The apparatus as set forth in claim 16, further comprising:
a first band-pass filter, disposed between the light source and the detector, and adapted to allow a first wavelength range of light to pass through.

18. The apparatus as set forth in claim 17, further comprising:
a second band-pass filter, provided on the chopper and adapted to allow a second wavelength range of light to pass through.

19. The apparatus as set forth in claim 16, further comprising:
a first band-pass filter, provided on the chopper, and adapted to allow a first wavelength range of light to pass through; and
a second band-pass filter, provided on the chopper, and adapted to allow a second wavelength range of light to pass through, wherein:
the notch filter and the first band-pass filter are aligned on the same optical path of the infrared light.

20. The apparatus as set forth in claim 16, wherein:
the airway adapter comprises windows through which the infrared light emitted form the light source passes; and
anti-fogging treatment is provided on the windows.
